(19) United States
(12) Patent Application Publication
(10) Pub. No.: US 2017/0046007 A1
(43) Pub. Date: Feb. 16, 2017

(54) INPUT DEVICE AND DISPLAY APPARATUS

(71) Applicant: Sharp Kabushiki Kaisha, Sakai City, Osaka (JP)

(72) Inventors: Daiji KITAGAWA, Sakai City (JP); Yoichi KUGE, Sakai City (JP); Masayuki HATA, Sakai City (JP)

(21) Appl. No.: 15/305,118

(22) PCT Filed: Apr. 27, 2015
(86) PCT No.: PCT/JP2015/062661

§ 371 Date: Oct. 19, 2016

(30) Foreign Application Priority Data
Apr. 28, 2014 (JP) 2014-092783

(51) Int. Cl. G06F 3/041; G06F 3/044

(52) U.S. Cl. CPC G06F 3/0418; G06F 3/044; G06F 3/0412; G06F 2203/04108

(57) ABSTRACT

An input device (1) includes a drive electrode provided in each of sensor areas (R1 to R4) and configured to receive a drive signal, a sense electrode configured to output a response signal to the drive signal, and a control unit (20) configured to input a drive signal to the drive electrode to drive each of the sensor areas, and detect, in each of the sensor areas, touch or approach of a target object to each of the sensor areas. The control unit (20) controls to simultaneously drive at least two of the sensor areas. Drive signals inputted to the drive electrodes in the at least two simultaneously driven sensor areas have drive frequencies different from each other.

### TECHNICAL FIELD

The present disclosure relates to a technique of sensing touch or approach of a target object by an input device such as a touch panel.

### BACKGROUND ART

In recent years, there have widely been used display apparatuses each including a display panel and a touch panel provided on the display panel. Also proposed is a technique of enlarging touch panels due to increase in size of display panels.

JP 2013-229010 A discloses a large touch panel having a plurality of detection areas. This touch panel includes controllers each of which is provided for a corresponding one of the detection areas and is configured to detect a touched position in the detection area and calculate, in accordance with the detected touched position, a position on the entire touch panel corresponding to the touched position.

### SUMMARY OF THE INVENTION

The above conventional technique does not achieve an adequate mechanism for noise reduction in a case where a plurality of sensor areas is driven in an input device such as a touch panel. In view of this, the present application discloses an input device having a plurality of sensor areas and achieving noise reduction.

An input device according to the present disclosure has a plurality of sensor areas. The input device includes: a drive electrode provided in each of the sensor areas and configured to receive a drive signal; a sense electrode provided in each of the sensor areas and configured to output a response signal to the drive signal; and a control unit configured to input a drive signal to the drive electrode in each of the sensor areas to drive the sensor areas and detect, in each of the sensor areas, touch or approach of a target object to each of the sensor areas by means of the sense electrode in each of the sensor areas. The control unit controls to simultaneously drive at least two of the sensor areas. Drive signals inputted to the drive electrodes in the at least two simultaneously driven sensor areas have drive frequencies different from each other.

The present disclosure embodies an input device having a plurality of sensor areas and achieving noise reduction.

### BRIEF DESCRIPTION OF DRAWINGS

FIG. 1 is a block diagram depicting an exemplary configuration of an input device according to an embodiment 1.

FIG. 2 is a diagram depicting an exemplary configuration of the touch panel of FIG. 1.

FIG. 3 exemplifies waveforms of drive signals inputted to drive electrodes 5 and a waveform of a response signal outputted from a sense electrode 4 in the touch panel of FIG. 2.

FIG. 4 is a block diagram depicting an exemplary configuration of an input device according to an embodiment 2.

FIG. 5 is a chart of exemplary data indicating assigned drive frequencies and conditions of use thereof.

FIG. 6 is a chart of data according to a modification example, indicating assigned drive frequencies N1 to N8 and conditions of use thereof.

FIG. 7 is a block diagram of an input device according to a modification example of the embodiment 2.

FIG. 8 is a block diagram depicting an exemplary configuration of a sensor-equipped display apparatus according to an embodiment 3.

FIG. 9 is a diagram depicting an exemplary configuration of an input device 1 according to an embodiment 4.

FIG. 10 exemplifies waveforms of drive signals inputted to drive electrodes 5-1 to 5-4 and waveforms of response signals outputted from sense electrodes 4-1 and 4-3 in the input device 1 of FIG. 9.

### DESCRIPTION OF EMBODIMENTS

An input device according to an embodiment of the present invention has a plurality of sensor areas. The input device includes: a drive electrode provided in each of the sensor areas and configured to receive a drive signal; a sense electrode provided in each of the sensor areas and configured to output a response signal to the drive signal; and a control unit configured to input a drive signal to the drive electrode in each of the sensor areas to drive the sensor areas and detect, in each of the sensor areas, touch or approach of a target object to each of the sensor areas by means of the sense electrode in each of the sensor areas. The control unit controls the plurality of sensor areas such that at least two of the sensor areas are simultaneously driven. Drive signals inputted to the drive electrodes in the at least two simultaneously driven sensor areas have drive frequencies different from each other.

In the at least two of the simultaneously driven sensor areas, the above configuration inhibits the drive signal of one of the sensor areas from affecting the response signal outputted from the sense electrode in a different one of the sensor areas. The input device having the plurality of sensor areas thus achieves noise reduction.

According to an aspect, the control unit includes a plurality of controllers configured to input the drive signal to the drive electrode in each of the sensor areas, and a frequency control unit configured to specify a drive frequency of each of the controllers. Optionally, the controllers are each provided for a corresponding one of the sensor areas. The plurality of controllers and the frequency control unit control the drive frequencies of the simultaneously driven sensor areas out of the plurality of sensor areas to have values different from each other.

According to an aspect, the control unit includes a plurality of controllers configured to input the drive signal to the drive electrode in each of the sensor areas. Optionally, each of the controllers includes a frequency control unit configured to specify a drive frequency of the controller itself to be different from drive frequencies of the other controllers. Optionally, the controllers are each provided for a corresponding one of the sensor areas. This configuration achieves control of the drive frequencies of the controllers to be different from one another.

According to an aspect, the frequency control unit controls the drive frequency of one of the controllers to be equal to a frequency not adopted as any one of the drive frequencies of the other controllers out of frequencies preliminarily assigned to all of the controllers. This achieves easier control of the drive frequencies of the plurality of controllers.

In the above configuration according to an aspect, at least two of frequencies different from one another are preliminarily assigned to each of the controllers. In this case, optionally, the frequency control unit controls the drive frequency of one of the controllers to be equal to one of the at least two frequencies assigned to the controller. This achieves easier control of the drive frequencies of the plurality of controllers.

According to an aspect, when abnormality is detected in a response signal outputted from the sense electrode in a corresponding one of the sensor areas, each of the controllers changes the drive frequency through control by the frequency control unit. This achieves driving of the sensor areas at appropriate drive frequencies according to states of the response signals of the sensor areas.

According to an aspect, the control unit inputs, to the drive electrode, a plurality of pulses at the drive frequency, and detects change in capacitance between the drive electrode and the sense electrode in accordance with a response signal to the plurality of pulses. This achieves accurate detection of the change in capacitance.

According to an aspect, the input device includes a plurality of touch panels. In this case, optionally, the touch panels each have a corresponding one of the sensor areas, and the drive electrode and sense electrode provided in the corresponding one of the sensor areas, and the touch panels are disposed to flatly locate the plurality of sensor areas. This embodies the input device including the plurality of touch panels and achieving noise reduction. The touch panels are thus easily increased in size, for example.

The present invention also provides a sensor-equipped display apparatus according to an embodiment, including the input device and a display panel having a display area positioned to be overlapped with the plurality of sensor areas of the input device.

Embodiments of the present invention will be described in detail below with reference to the drawings. Identical or corresponding portions in the drawings will be denoted by identical reference signs and will not be described repeatedly. For clearer description, the drawings to be referred to hereinafter may depict simplified or schematic configurations or may not depict some of constructional elements. The constructional elements in each of the drawings may not necessarily be depicted in actual dimensional ratios.

### Embodiment 1

(Exemplary Configuration of Input Device)

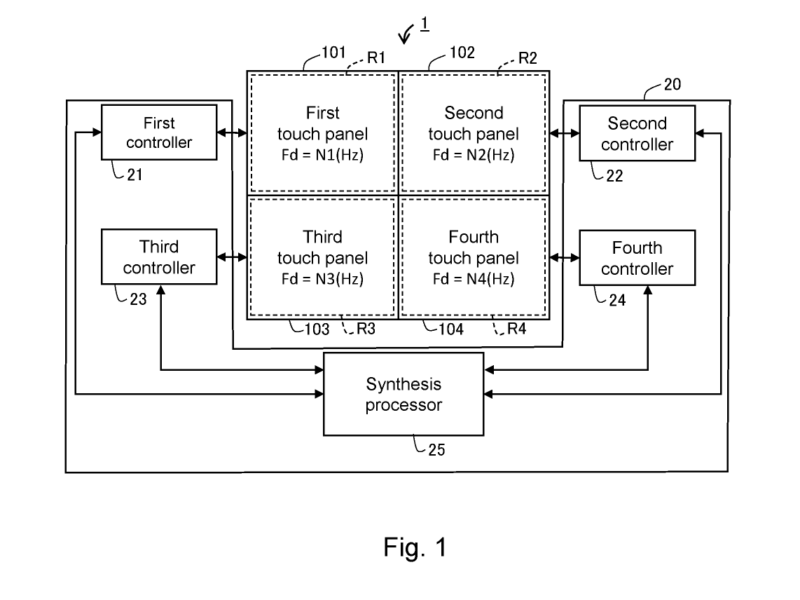

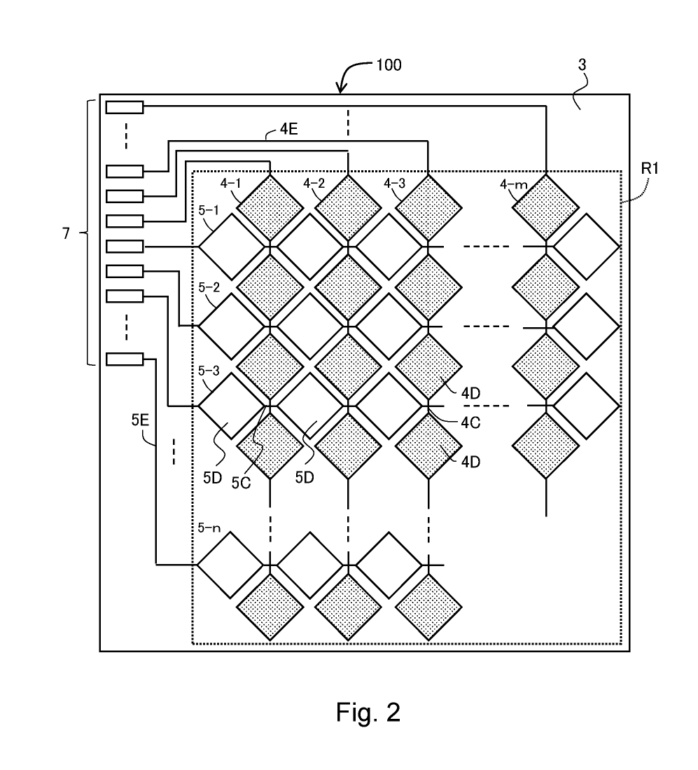

FIG. 1 is a block diagram depicting an exemplary configuration of an input device according to the embodiment 1. An input device 1 exemplifies an input device having a plurality of sensor areas. The input device 1 is configured to drive each of the sensor areas and detect a target object such as a finger or a pen in each of the sensor areas. Specifically, the input device 1 includes a plurality of touch panels, namely, first to fourth touch panels 101 to 104, and a control unit 20. The first to fourth touch panels 101 to 104 include sensor areas R1 to R4, as well as drive electrodes and sense electrodes provided in the sensor areas R1 to R4, respectively. The drive electrodes and the sense electrodes will specifically be exemplified later with reference to FIG. 2.

The control unit 20 controls drive signals inputted to the first to fourth sensor areas R1 to R4 to simultaneously drive at least two of the sensor areas R1 to R4. According to an aspect, the control unit 20 is configured to control drive signals of the sensor areas to at least partially overlap driving periods for input of the drive signals in at least two of the sensor areas R1 to R4. The control unit 20 is not necessarily required to synchronize drive signals of the first to fourth sensor areas R1 to R4.

The control unit 20 according to the present embodiment includes first to fourth controllers 21 to 24 each provided for a corresponding one of the sensor areas R1 to R4, and a synthesis processor 25.

Hereinafter, when the first touch panel 101, the second touch panel 102, the third touch panel 103, and the fourth touch panel 104 are not distinguished from one another, each of these touch panels will generically be referred to as a touch panel 100. Similarly, when the first sensor area R1, the second sensor area R2, the third sensor area R3, and the fourth sensor area R4 are not distinguished from one another, each of these sensor areas will generically be referred to as a sensor area R. When the first controller 21, the second controller 22, the third controller 23, and the fourth controller 24 are not distinguished from one another, each of these controllers will generically be referred to as a controller 2.

In a case where the touch panel 100 is an electrostatic capacitance touch panel according to a mutual capacitance system, a drive signal outputted from the controller 2 to a drive electrode is received by a sensing circuit of the controller 2 for monitoring of capacitance between the drive electrode and a sense electrode. When a target object touches or approaches the sensor area R, capacitance changes at a node between the drive electrode and the sense electrode corresponding to a position of the touch or approach. This enables recognition of the touch or approach. Coordinates of the touch or approach is calculated from the position of the node.

In this manner, the first to fourth controllers 21 to 24 each input a drive signal to a drive electrode in a corresponding one of the sensor areas and detect touch or approach of a target object to the corresponding sensor area in accordance with a response signal outputted from a sense electrode. The target object is thus detected independently in each of the sensor areas R1 to R4. The first to fourth controllers 21 to 24 are configured to drive the first to fourth sensor areas R1 to R4 at timings independent from one another.

For example, at least two of the first to fourth sensor areas R1 to R4 are driven simultaneously and parallelly. This configuration reduces a sensing period for scan of all of the first to fourth sensor areas R1 to R4. All of the first to fourth sensor areas R1 to R4 is thus improved in scanning rate. The first to fourth sensor areas R1 to R4 are each configured to have the driving period from input of a drive signal to a drive electrode to output of a response signal from a sense electrode. According to an aspect, at least two of the first to fourth sensor areas R1 to R4 have the driving periods at least partially overlapped with each other. For example, all of the driving periods of the first to fourth sensor areas can be provided simultaneously, or the driving periods of two of the first to fourth sensor areas can be overlapped with each other.

The synthesis processor 25 synthesizes detection results of the first to fourth controllers 21 to 24, and generates a result of detection of a target object in the plurality of sensor areas, i.e. all of the first to fourth sensor areas R1 to R4. The detection result includes data indicating a position of a detected target object, data indicating distribution of detection values in the first to fourth sensor areas R1 to R4, or the like.

According to an aspect, the synthesis processor 25 specifies an input position (coordinates) on a coordinate plane preset to all of the first to fourth sensor areas R1 to R4 in accordance with detection result data outputted from the controllers 2. The synthesis processor 25 is also configured to acquire from the controller 2 or generate, in addition to the input position, status information on a state of input operation, hover information on a position in the air, or the like.

In an exemplary case, touch coordinates acquired by each of the touch panels 100 are transmitted to the synthesis processor 25 via a corresponding one of the controllers 2. The synthesis processor 25 converts the coordinates acquired by each of the touch panels 100 in accordance with disposition of the touch panels 100. In a case where X-Y coordinates of one of the touch panels 100 have 200×100 values, the upper left first touch panel 101 has X=0 to 199 and Y=0 to 99, the upper right second touch panel 102 has X=200 to 399 and Y=0 to 99, the lower left third touch panel 103 has X=0 to 199 and Y=100 to 199, and the lower right fourth touch panel 104 has X=200 to 399 and Y=100 to 199.

A frequency of a drive signal inputted to a drive electrode will be referred to as a drive frequency. Such a drive frequency is also called a scan frequency. In a case where the first to fourth touch panels 101 to 104 are simultaneously driven in the configuration depicted in FIG. 1, the control unit 20 controls drive frequencies of the first to fourth touch panels to be different from one another. Specifically, the first to fourth controllers 21 to 24 each input, to a drive electrode in a corresponding one of the sensor areas, a drive signal of a drive frequency different from the drive frequencies of the other controllers. The first to fourth touch panels 101 to 104 are driven at the drive frequencies different from one another. Assuming that the first to fourth touch panels 101 to 104 have drive frequencies Fd denoted by N1, N2, N3, and N4, respectively, a relation N1≠N2≠N3≠N4 is established.

If there is exogenous noise of a frequency similar to a drive frequency, the sensing circuit of the controller 2 may fail to sense accurately. In a case where a circuit in an AC adapter connected to the input device 1 has a frequency similar to a drive frequency, noise may be injected via a GND to cause erroneous detection or the like. The drive frequencies N1, N2, N3, and N4 of the first to fourth sensor areas R1 to R4 are thus preferably selected so as not to be equal to the frequency of the exogenous noise.

The plurality of sensor areas R1 to R4 is arrayed in the present embodiment. The drive frequency of each of the first to fourth sensor areas R1 to R4 possibly serves as exogenous noise to the controllers 2 for the other sensor areas. When the drive frequencies of the first to fourth touch panels 101 to 104 are set to have values different from one another, each of the first to fourth touch panels 101 to 104 is less likely to be affected by a drive signal of a different one of the touch panels driven simultaneously. Noise reduction is thus achieved.

(Exemplary Configuration of Touch Panel)

FIG. 2 is a diagram depicting an exemplary configuration of the touch panel 100 in the input device 1 of FIG. 1. FIG. 2 exemplifies a case where the touch panel 100 includes a substrate 3 provided with a plurality of drive electrodes 5-1, 5-2, . . . , and 5-n (n is a natural number) extending in a first direction (transversely in this case) and a plurality of sense electrodes 4-1, 4-2, . . . , and 4-m (m is a natural number) extending in a second direction (longitudinally in this case) different from the first direction. Hereinafter, when the plurality of drive electrodes 5-1 to 5-n is not distinguished from one another, each of these drive electrodes will generically be referred to as a drive electrode 5. When the plurality of sense electrodes 4-1 to 4-m is not distinguished from one another, each of these drive electrodes will generically be referred to as a sense electrode 4.

The drive electrode 5 includes a plurality of electrode pads 5D aligned in the first direction and connecting wires 5C connecting the two adjacent electrode pads 5D. Similarly, the sense electrode 4 includes a plurality of electrode pads 4D aligned in the second direction and connecting wires 4C connecting the two adjacent electrode pads 4D. Each of the electrode pads 4D and 5D has a rectangular shape and the connecting wires 4C or 5D are connected to two of four vertexes of the rectangular shape. The electrode pads 5D of the drive electrode 5 and the electrode pads 4D of the sense electrode 4 are disposed to be adjacent to each other. FIG. 2 exemplifies a case where the electrode pads 5D of the drive electrode 5 each have four sides respectively facing sides of the four electrode pads 4D of the sense electrodes 4.

The connecting wires 5C of the drive electrodes 5 each cross with a corresponding one of the connecting wires 4C of the sense electrodes 4 in a planar view. The drive electrodes 5 and the sense electrodes 4 are not electrically connected and are insulated from each another. There is provided an insulating layer (not depicted) between the drive electrode 5 and the sense electrode 4 at a point (node) where the drive electrode 5 cross with the sense electrode 4 in a planar view.

FIG. 2 exemplifies a case where the plurality of rectangular electrode pads 5D and 4D of the drive electrodes 5 and the sense electrodes 4 is arrayed in a matrix form having rows and columns. The sense electrodes 4 configuring the columns are each connected to a corresponding terminal 7 provided outside the sensor area R via lead wiring 4E. The drive electrodes 5 configuring the rows are each connected to a corresponding terminal 7 via lead wiring 5E. The terminals 7 are connected with the controller 2. In this case, the controller 2 inputs a drive signal to each of the drive electrodes via the corresponding terminal 7 and the corresponding lead wiring 5E. The controller 2 also receives a response signal outputted from each of the sense electrodes 4 via the corresponding terminal 7 and the corresponding lead wiring 4E.

The drive electrodes 5 and the sense electrodes 4 are not limited to the above example in terms of their disposition, shapes, and numbers. The sense electrodes 4 and the drive electrodes 5 are alternatively disposed by replacing each other. Each of the electrode pads of the sense electrodes 4 and the drive electrodes 5 does not necessarily have the rectangular shape. The sense electrodes 4 and the drive electrodes 5 may not form the pattern of the arrayed electrode pads but may alternatively form a linear pattern or the like. The drive electrode 5 is also called a drive line, a driver electrode, or a transmitter electrode. The sense electrode 4 is also called a sense line, a detector electrode, or a receiver electrode 4.

The controller 2 controls a drive signal of the drive electrode 5 and receives a voltage signal of the sense electrode 4 to detect change in capacitance between the electrode pad 5D of the drive electrode 5 and the adjacent electrode pad 4D of the sense electrode 4. The controller 2 is configured to specify a position of a target object approaching or touching the touch panel 100 in accordance with the detected change in capacitance. According to an aspect, the controller 2 is configured by a semiconductor chip (not depicted) provided on the substrate 3 of the touch panel 100 or on an FPC (not depicted) connected to the touch panel 100.

(Exemplary Operation)

The touch panel 100 depicted in FIG. 2 is according to an electrostatic capacitance system. In a case where the a target object such as a finger or a pen approaches or touches the electrode pad 5D of the drive electrode 5 and the adjacent electrode pad 4D of the sense electrode 4, capacitance changes between the electrode pad 5D and the electrode pad 4D. Approach or touch of the target object is sensed by detection of the change in capacitance.

The controller 2 inputs a drive signal to the drive electrode 5 and receives a response signal from the sense electrode 4 to obtain a value of capacitance between the drive electrode 5 and the sense electrode 4. The value of capacitance is exemplified by values corresponding to nodes between the drive electrodes 5 and the sense electrodes 4.

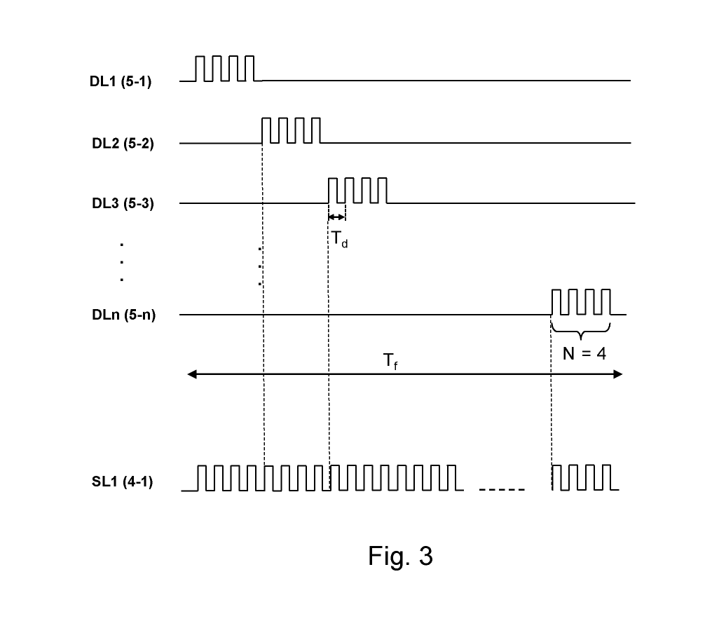

FIG. 3 exemplifies waveforms of drive signals inputted to the drive electrodes 5 and a waveform of a response signal outputted from the sense electrode 4 in the touch panel 100 of FIG. 2. FIG. 3 includes DL1(5-1), DL2(5-2), DL3(5-3), . . . , and DLn(5-n) in an upper portion indicating the waveforms of the drive signals inputted respectively to the drive electrodes 5-1, 5-2, 5-3, . . . , and 5-n in the sensor area R. FIG. 3 includes SL1(4-1) in a lower portion indicating the waveform of the response signal outputted from the single sense electrode 4-1 in the sensor area R.

FIG. 3 exemplifies a case where pulses are sequentially applied to each of the drive electrodes 5-1, 5-2, 5-3, . . . , and 5-n in the sensor area R at a cycle Td a predetermined number of times, i.e. N times (N=4 in this exemplary case). The number of times N is also referred to as an integration number of times or the like. The controller 2 detects voltage signals of the plurality of sense electrodes 4-1 to 4-m crossing with the drive electrodes 5 in synchronization with the pulses applied to the drive electrodes 5. A period necessary for scan of the sensor area R, i.e. the sensing period, corresponds to a period Tf from application of pulses the N times to the plurality of drive electrodes 5-1 to 5-n in the sensor area R to receipt of response pulses.

FIG. 3 exemplifies a case where the drive frequency Fd has a reciprocal of the pulse cycle Td of a drive signal, so that a relation Fd=1/Td is established. In this exemplary case, the pulses of the drive signal have a frequency serving as a drive frequency. According to an aspect, a value of the drive frequency Fd or the pulse cycle Td is preliminarily stored in a memory as a set value and the controller 2 is configured to operate in accordance with the value. This memory is incorporated in the controller 2 or is accessible from the controller 2. According to an aspect, the configuration depicted in FIG. 1 allows the cycles Td (i.e. the drive frequencies Fd) different from one another to be preset to the first to fourth controllers 21 to 24.

In a case where a single pulse is applied in the waveform DL1(5-1), each of the sense electrodes 4-1 to 4-m outputs a response pulse to this pulse. In this case, the response pulse from the sense electrode 4-1 has a waveform reflecting capacitance at the node between the drive electrode 5-1 and the sense electrode 4-1, for example. A charge generated by this response pulse and corresponding to the capacitance at the node between the drive electrode 5-1 and the sense electrode 4-1 is transported to storage capacitance in the controller 2 and is retained. Such charge transport and retention are repeated the N times (N=4 in this exemplary case). The controller 2 then measures a voltage due to the charges stored in the storage capacitance through the N times of pulses. Determination is made in accordance with a measurement value as to whether or not a there is target object at a position corresponding to the node between the drive electrode 5-1 and the sense electrode 4-1 or as to the value of capacitance.

In the above exemplary case, input of a plurality (N times) of pulses to the drive electrode 5 leads to acquisition of a plurality (N times) response pulses as a response signal thereto. Measurement of a capacitance value according to a plurality of response pulses leads to obtaining an average value of a plurality of measurement values. Averaging the measurement values achieves reduction in noise component in the measurement values. Even in a case where one of the N response pulses includes a noise component enough to seriously affect measurement results, a noise component included in the average value of the N response pulses may be small enough to ignore its influence.

In another case where noise has a frequency equal or approximate to a frequency of a response pulse, a noise component is unlikely to be decreased by averaging the measurement values with the plurality of response pulses. Such a remaining noise component may seriously affect the measurement results. According to the present embodiment, one of the touch panels 100 has a drive frequency different from a drive frequency of a different one of the touch panels adjacent thereto, so as to reduce noise of a frequency equal to the drive frequency of the touch panel 100 itself. The first to fourth touch panels 101 to 104 of FIG. 1 are configured to average measurement results with a plurality of pulses as a drive signal and achieve noise reduction more effectively.

### Embodiment 2

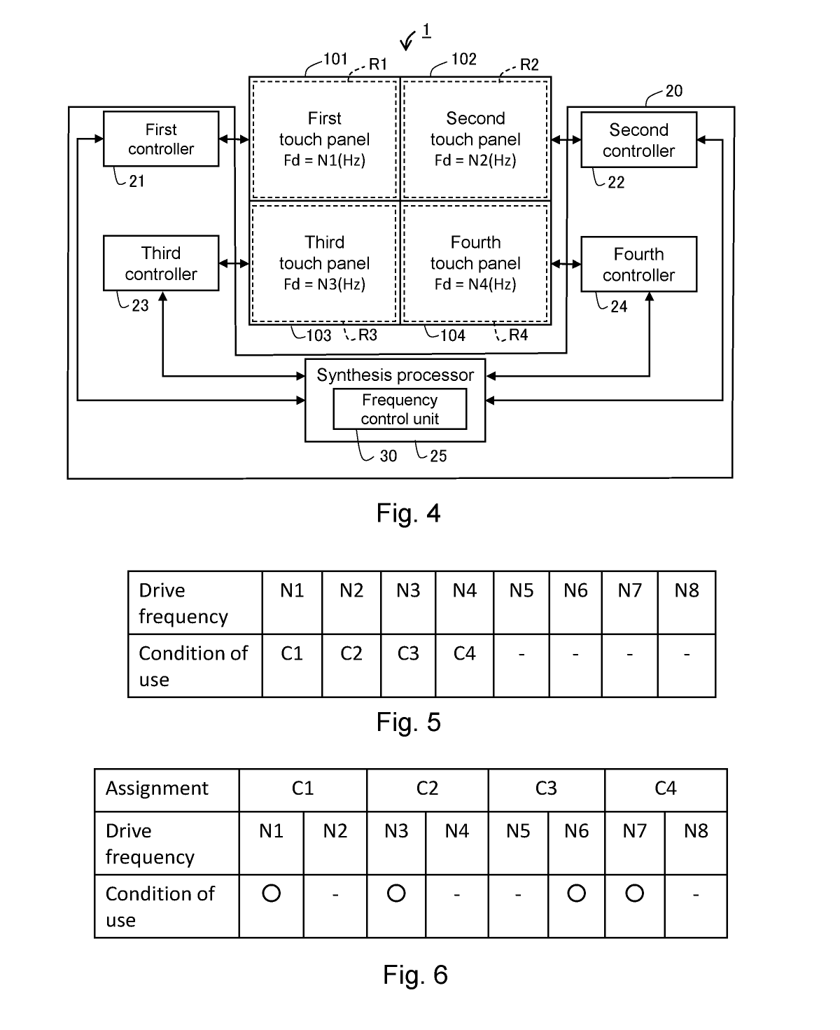

FIG. 4 is a block diagram depicting an exemplary configuration of an input device according to the embodiment 2. In an input device 1 depicted in FIG. 4, a synthesis processor 25 includes a frequency control unit 30. The frequency control unit 30 controls drive frequencies of first to fourth controllers 21 to 24. Specifically, the frequency control unit 30 specifies a drive frequency of each of the first to fourth controllers 21 to 24. The first to fourth controllers 21 to 24 input drive signals of the drive frequencies specified by the frequency control unit 30, to the drive electrodes in the first to fourth sensor areas R1 to R4. The frequency control unit 30 specifies drive frequencies of the controllers 2 such that simultaneously driven touch panels out of first to fourth touch panels 101 to 104 have drive frequencies different from each other.

According to an aspect, the plurality of controllers, i.e. all of the first to fourth controllers 21 to 24, is preliminarily assigned with frequencies applicable as drive frequencies. The number of the preliminarily assigned frequencies is preferably larger than the number of the controllers. The number of the controllers 2 is four in this exemplary case, so that eight frequencies N1 to N8 more than four are assigned. According to an aspect, the assigned frequencies are stored in a memory accessible from the controllers 2.

The frequency control unit 30 is configured to be accessible to the assigned frequencies N1 to N8 and data indicating conditions of use of the frequencies N1 to N8. According to an aspect, such data is stored in a memory included in the control unit 20 or an external memory accessible from the control unit 20. FIG. 5 is a chart of exemplary data indicating the assigned drive frequencies N1 to N8 and the conditions of use thereof. The chart of FIG. 5 stores the frequencies N1 to N8 applicable as drive frequencies of the first to fourth sensor areas R1 to R4 in association with the conditions of use of the frequencies N1 to N8. In FIG. 5, the first to fourth controllers 21 to 24 are denoted by C1 to C4, respectively. For example, the drive frequency “N1” and the first controller 21 “C1” are stored in association with each other. This indicates that the first controller 21 adopts the drive frequency N1.

In a case where a drive frequency of one of the first to fourth controllers 21 to 24 is changed, the frequency control unit 30 is configured to refer to a chart as in FIG. 5 stored in the memory and acquire a frequency that is not adopted by the other controllers. In the case where the drive frequency of one of the first to fourth controllers 21 to 24 is changed, the frequency control unit 30 is also configured to update the data in the chart of FIG. 5 in accordance with the changed drive frequency. The frequency control unit 30 is thus configured to control drive frequencies of the first to fourth controllers 21 to 24 to be different from one another.

In a case where abnormality is detected in a response signal outputted from a sense electrode in the sensor area R, the frequency control unit 30 is configured to command the controller 2 to change the drive frequency of the sensor area R. In a case where a response signal includes an amount of noise exceeding a predetermined level in one of the first to fourth sensor areas R1 to R4, the frequency control unit 30 is configured to command the controller for the sensor area to change the drive frequency of the sensor area.

Whether or not a response signal is abnormal is determined in accordance with whether or not an effective measurement value is obtained from the response signal, for example. According to an aspect, the frequency control unit 30 is configured to determine whether or not a response signal is abnormal in accordance with whether or not a capacitance value obtained from the response signal falls within an allowable range. The frequency control unit 30 is configured to determine that a response signal is abnormal in a case where a capacitance value obtained from the response signal does not fall within a preset allowable range. The frequency control unit 30 is configured to determine that a response signal is abnormal in another case where change in capacitance exceeding a predetermined value is observed at nodes between a sense electrode and all of the corresponding drive electrodes. Detected as being abnormal is a state hardly caused by ordinary touch operation (e.g. a target object in a bar shape is placed across a screen). The frequency control unit 30 is configured to detect measurement abnormality due to frequency interference in these manners.

In a case of determining a response signal as being abnormal, the frequency control unit 30 is configured to control driving so as to avoid a frequency of a drive signal adopted when a response signal thereto is acquired. This configuration achieves selection of an appropriate drive frequency according to a noise condition. Such change in drive frequency is made in accordance with a technique of frequency hopping (FH) or the like.

How to assign drive frequencies is not limited to the exemplary case described above. According to an aspect, at least two of frequencies different from one another are preliminarily assigned to each of the controllers. In this case, the frequency control unit 30 is configured to control the drive frequency of one of the first to fourth controllers 21 to 24 to be equal to one of the at least two frequencies assigned to the controller.

FIG. 6 is a chart of data according to a modification example, indicating the assigned drive frequencies N1 to N8 and conditions of use thereof. FIG. 6 exemplifies a case where two of the frequencies (N1 to N8) different from one another are assigned to each of the controllers. For example, “C1” indicating the first controller 21 is stored in association with the drive frequencies N1 and N2. This indicates that the drive frequencies N1 and N2 are assigned to the first controller 21. Also stored in association with the drive frequencies N1 to N8 is data on whether or not the frequencies are in use. In this exemplary case, circles indicate an in-use condition.

In this case, the frequency control unit 30 is configured to determine which one of the at least two drive frequencies assigned to each of the controllers is adopted in accordance with an amount of noise included in a response signal.

Control of drive frequencies by the frequency control unit 30 is not limited to such change in drive frequency according to a noise amount of a response signal. The frequency control unit 30 is alternatively configured to change a drive frequency in a predetermined order or at a random timing.

(Frequency Control Unit according to Modification Example)

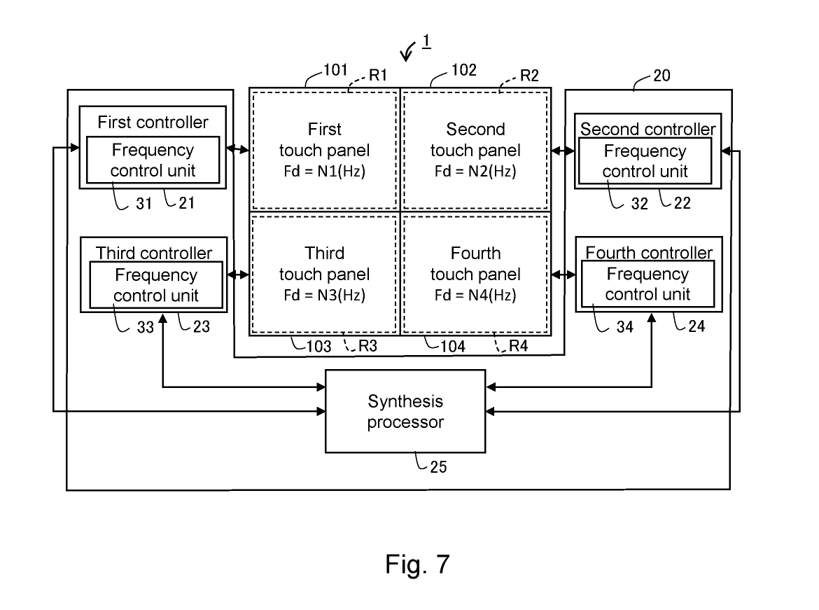

FIG. 4 depicts the configuration in which the synthesis processor 25 includes the frequency control unit 30 configured to specify drive frequencies of the first to fourth controllers 21 to 24. In contrast, each of the controllers 2 alternatively includes a frequency control unit as exemplified in FIG. 7. FIG. 7 exemplifies a configuration in which the first to fourth controllers 21 to 24 include frequency control units 31 to 34, respectively. The frequency control unit 31 in the first controller 21 sets a drive frequency of the first controller 21 to be different from drive frequencies of the other controllers 22 to 24. Each of the frequency control units 32 to 34 in the second to fourth controllers similarly controls its drive frequency so as to be unequal to drive frequencies of the other controllers.

In an exemplary case, each of the frequency control units 31 to 34 in the controllers 2 is configured to acquire drive frequencies of the other controllers and control a drive frequency of a drive signal thereof in accordance with the acquired drive frequencies. According to an aspect, the frequency control units 31 to 34 are configured to be accessible to the chart of FIG. 5 or 6. Each of the frequency control units 31 to 34 is configured to find a drive frequency not adopted by the other controllers with reference to data indicating conditions of use of the assigned frequencies. The frequency control units 31 to 34 are also configured to update the data by adding change in drive frequency when each of the frequency control units 31 to 34 changes a drive frequency thereof.

According to a modification example, each of the frequency control units 31 to 34 is configured to select its drive frequency out of frequencies assigned to a corresponding one of the controllers 2. As exemplified in FIG. 6, at least two of the frequencies N1 to N8 different from one another are preliminarily assigned to each of the controllers. In this case, each of the frequency control units 31 to 34 is configured to select a drive frequency thereof from the at least two frequencies assigned to a corresponding one of the controllers.

The embodiment described above achieves change in drive frequency so as to avoid a frequency band including much noise. Specifically, the frequency control unit 30 changes a drive frequency of a sensor area so as to achieve sensing with a drive signal in a frequency band including less noise.

In the above embodiment, the preliminarily assigned frequencies N1 to N8 are preferably set to avoid frequencies of exogenous noise from equipment such as a display panel and an AC adapter disposed adjacent to the input device 1.

### Embodiment 3

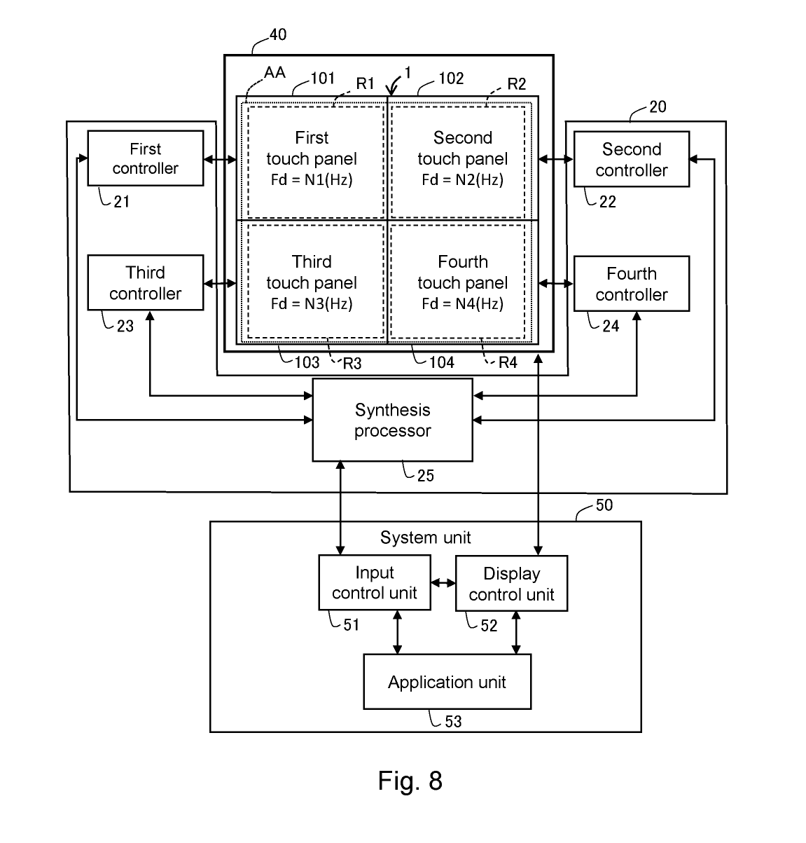

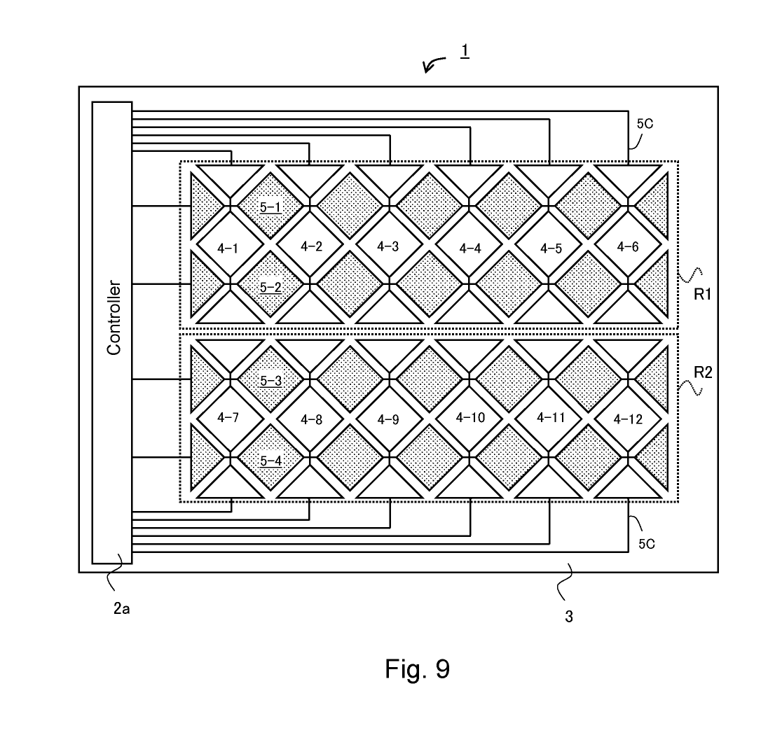

The embodiment 3 relates to a sensor-equipped display apparatus including an input device 1 and a display panel. The input device 1 according to the present embodiment can be configured similarly to the input device 1 according to the embodiment 1 or 2. FIG. 8 is a block diagram depicting an exemplary configuration of the sensor-equipped display apparatus according to the embodiment 3.

The sensor-equipped display apparatus depicted in FIG. 8 includes the input device 1, a display panel 40, and a system unit 50. The input device 1 includes first to fourth touch panels 101 to 104 and a control unit 20. The input device 1 can be configured similarly to that depicted in FIG. 1. The display panel 40 is disposed to be overlapped with the input device 1. Specifically, the display panel is disposed such that first to fourth sensor areas R1 to R4 of the input device 1 are overlapped with a display area AA of the display panel.

The display area AA of the display panel 40 is configured to display an image. The display area AA includes arrayed pixels configured to display an image. The display panel 40 is configured as a liquid crystal panel or the like. The liquid crystal panel includes an active matrix substrate, a counter substrate, and a liquid crystal layer provided between the active matrix substrate and the counter substrate.

The first to fourth sensor areas R1 to R4 of the input device 1 are disposed to be at least partially overlapped with the display area AA, so that the input device 1 is configured to receive input operation to an image displayed in the display area AA.

The system unit 50 is configured to control display of the display panel in accordance with information inputted to the input device 1. In an exemplary case, the system unit 50 includes an input control unit 51, a display control unit 52, and an application unit 53. The input control unit 51 controls driving the input device 1 and acquires positional information or the like on a target object detected by the input device 1. The application unit 53 executes various applications for exchange of data with the input device 1 and the display panel 40. The display control unit 52 controls an image displayed on the display panel 40. The input control unit 51, the display control unit 52, and the application unit 53 are configured by a processor dedicated to image processing, a CPU, a combination thereof, or the like.

In this manner, a large sensor-equipped display apparatus is embodied by disposing a plurality of touch panels to be overlapped with the display area AA of the single display panel 40. This configuration enables provision of a display apparatus having sensors configured to quickly scan a large sensor area.

Drive frequencies of the first to fourth sensor areas R1 to R4 are preferably selected to avoid a frequency of noise caused by the driven display panel 40. According to an aspect, a frequency in a band not including the frequency of the noise caused by the display panel 40 is set as a drive frequency applicable to the first to fourth controllers 21 to 24.

### Embodiment 4

FIG. 9 is a diagram depicting an exemplary configuration of an input device 1 according to the embodiment 4. The input device 1 depicted in FIG. 9 has a plurality of sensor areas R1 and R2 aligned in one direction (longitudinally in this exemplary case). The plurality of sensor areas R1 to R4 is arrayed in the matrix form in the above embodiments 1 to 3. In contrast, the number and disposition of the sensor areas are not limited to those according to the above exemplary case. As exemplified in FIG. 9, the plurality of sensor areas is aligned in one direction. Furthermore, the sensor areas are not limited in shape to the above exemplary case.

The controllers are each provided for a corresponding one of the sensor areas in the embodiments 1 to 3. In contrast, the present embodiment exemplifies a single controller configured to control a plurality of sensor areas. FIG. 9 exemplifies a controller 2a connected to the plurality of sensor areas R1 and R2. Specifically, the controller 2a is connected with drive electrodes and sense electrodes in the plurality of sensor areas R1 and R2. The controller 2a is achieved by modifying the control unit 20.

According to an aspect, the controller 2a is configured to input a drive signal simultaneously to each of the drive electrodes in the plurality of sensor areas R1 and R2. The plurality of sensor areas R1 and R2 is thus scanned simultaneously for a better scanning rate.

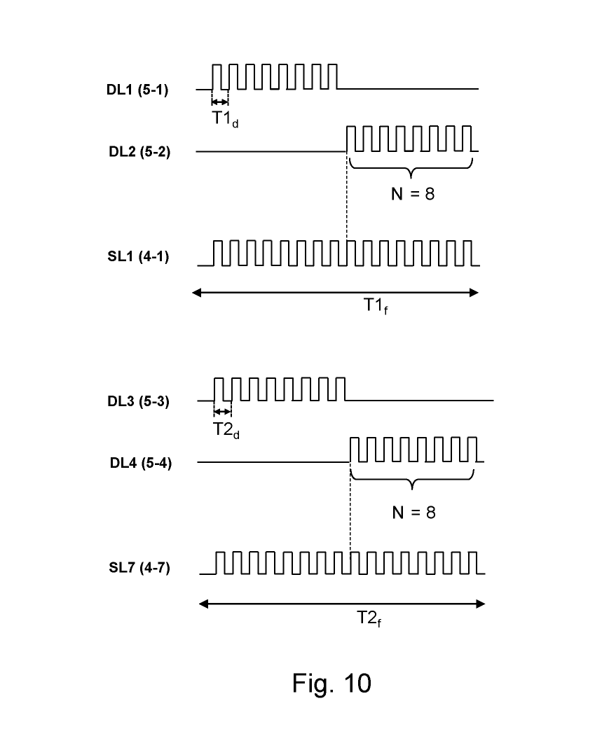

FIG. 10 exemplifies waveforms of drive signals inputted to drive electrodes 5-1 to 5-4 and waveforms of response signals outputted from sense electrodes 4-1 and 4-7 in the plurality of sensor areas R1 and R2 of the input device 1 of FIG. 9. FIG. 10 includes DL1(5-1) and DL2(5-2) in an upper portion indicating the waveforms of the drive signals inputted respectively to the drive electrodes 5-1 and 5-2 in the sensor area R1. FIG. 10 includes SL1(4-1) indicating the waveform of the response signal outputted from the single sense electrode 4-1 in the sensor area R1. FIG. 10 includes DL3(5-3) and DL4(5-4) in a lower portion indicating the waveforms of the drive signals inputted respectively to the drive electrodes 5-3 and 5-4 in the sensor area R2. FIG. 10 includes SL7(4-7) indicating the waveform of the response signal outputted from the single sense electrode 4-7 in the sensor area R2.

FIG. 10 exemplifies a case where pulses are sequentially applied to each of the drive electrodes 5-1 and 5-2 in the sensor area R1 at a cycle T1d a predetermined number of times, i.e. N times (N=8 in this exemplary case). Simultaneously, pulses are sequentially applied to each of the drive electrodes 5-3 and 5-4 in the sensor area R2 at a cycle T2d a predetermined number of times, i.e. the N times (N=8 in this exemplary case). In this exemplary case, the cycle T1d of the pulses in the sensor area R1 is different from the cycle T2d of the pulses in the sensor area R2. In other words, the sensor area R1 is different in drive frequency from the sensor area R2. Each of the sensor area R1 and the sensor area R2 thus has less noise caused by a drive signal of the other sensor area.

FIG. 10 exemplifies a case where the sensor area R1 and the sensor area R2 have an equal integration number of times N. The sensor area R1 and the sensor area R2 can alternatively have integration numbers of times different from each other. According to an aspect, the sensor area R1 and the sensor area R2 are different from each other in terms of the integration number of times N to equalize an operation period T1f of the sensor area R1 to an operation period T2f of the sensor area R2.

### Application Examples and Modification Examples of Embodiments

The input device 1 according to any one of the embodiments 1 to 4 is preferably applicable to a large touch panel. A larger touch panel is assumed to have a larger sensor area. Such a larger sensor area requires a longer period for scan of the sensor area due to increase in resistance of drive electrodes and sense electrodes, increase in the number of wiring, and the like. Scan may not be executed at a required rate in this case. In view of this, according to an aspect, the sensor area is divided into divisional sensor areas, which are driven simultaneously for detection of a target object in the sensor areas, to improve scanning rates of the sensor areas. The inventors have found that, in a case where a plurality of sensor areas is equal in drive frequency, a response signal of a sense electrode in each of the sensor areas is affected by noise due to a drive signal of the other sensor area. Noise in each of the sensor areas is reduced by setting drive frequencies of the sensor areas to be different from each another. This achieves a large touch panel with less noise.

The present invention also relates to various electronic equipment including the input device 1 according to any one of the embodiments 1 to 4. A display apparatus including the input device according to the present invention is applicable to a smartphone, a tablet terminal a game machine, a digital camera, a video camera, a media player, an electronic book reader, a general-purpose computer, a remote controller of any equipment, an on-vehicle panel, a car navigation system, a television system, an ATM, an electronic bulletin board, an electronic guide board, an electronic white board, an operation board also serving as a display of an apparatus used in a plant, and the like. The present invention also relates to an independent input device 1 provided with no display panel and applicable to various electronic equipment. This input device is applicable to an operation board, a button, a console, and the like of any equipment. Such electronic equipment can include sensor areas appropriate for a purpose thereof when equipped with the input device 1 according to any one of the embodiment 1 to 4.

The embodiments of the present invention have been described above, although the present invention should not be limited to these embodiments 1 to 4. The above embodiments exemplify sequential driving of sequentially inputting pulse signals to the plurality of drive electrodes 5. The present invention is also applicable to parallel driving of simultaneously inputting pulse signals to the plurality of drive electrodes 5. Such parallel driving achieves reduction in operation period in comparison to the sequential driving. The above embodiments exemplify the touch panel according to the mutual capacitance system, while the present invention is also applicable to a touch panel according to a self-capacitance system.

The plurality of sensor areas R1 to R4 according to any one of the embodiments 1 to 4 is provided as planes parallel to one another. Specifically, the drive electrodes and the sense electrodes in the plurality of sensor areas R1 to R4 are disposed in a single layer or in a plurality of different layers parallel to each other. According to an aspect, the drive electrodes 5 and the sense electrodes 4 in the plurality of sensor areas R1 to R4 are provided in layers parallel to a display plane of the display area AA. In another case where the plurality of sensor areas R1 to R4 is not disposed in parallel, an exemplary input device 1 has sensor areas provided at the top and a side.

The display panel is not limited to a liquid crystal display. The display panel may be configured as an organic EL display, a plasma display, an electrophoresis display, a MEMS display, or the like.

1. An input device having a plurality of sensor areas, the input device comprising:
a drive electrode provided in each of the sensor areas and configured to receive a drive signal;
a sense electrode provided in each of the sensor areas and configured to output a response signal to the drive signal; and
a control unit configured to input a drive signal to the drive electrode in each of the sensor areas to drive the sensor areas and detect, in each of the sensor areas, touch or approach of a target object to each of the sensor areas by means of the sense electrode in each of the sensor areas; wherein
the control unit controls the plurality of sensor areas such that at least two of the sensor areas are simultaneously driven, and
drive signals inputted to the drive electrodes in the at least two of the sensor areas have drive frequencies different from each other.

2. The input device according to claim 1, wherein
the control unit includes
a plurality of controllers each provided for a corresponding one of the sensor areas and configured to input the drive signal to the drive electrode in each of the sensor areas, and
a frequency control unit configured to specify a drive frequency of each of the controllers to be different from drive frequencies of the other controllers.

3. The input device according to claim 1, wherein
the control unit includes a plurality of controllers each provided for a corresponding one of the sensor areas and configured to input the drive signal to the drive electrode in each of the sensor areas, and
each of the controllers includes a frequency control unit configured to specify a drive frequency of the controller itself to be different from drive frequencies of the other controllers.

4. The input device according to claim 2, wherein
the frequency control unit controls the drive frequency of one of the controllers to be equal to a frequency not adopted as any one of the drive frequencies of the other controllers out of frequencies preliminarily assigned to all of the controllers.

5. The input device according to claim 2, wherein
at least two of frequencies different from one another are preliminarily assigned to each of the controllers, and
the frequency control unit controls the drive frequency of one of the controllers to be equal to one of the at least two frequencies assigned to the controller.

6. The input device according to claim 2, wherein
when abnormality is detected in a response signal outputted from the sense electrode in a corresponding one of the sensor areas, each of the controllers changes the drive frequency through control by the frequency control unit.

7. The input device according to claim 1, wherein
the control unit inputs, to the drive electrode, a plurality of pulses at the drive frequency, and detects change in capacitance between the drive electrode and the sense electrode in accordance with a response signal to the plurality of pulses.

8. The input device according to claim 1 further comprising:
a plurality of touch panels; wherein
the touch panels each have a corresponding one of the sensor areas, and the drive electrode and sense electrode provided in the corresponding one of the sensor areas, and
the touch panels are disposed to flatly locate the plurality of sensor areas.

9. A sensor-equipped display apparatus comprising:
the input device according to claim 1; and
a display panel having a display area positioned to be overlapped with the plurality of sensor areas of the input device.
